(19) United States
(12) Patent Application Publication
(10) Pub. No.: US 2025/0212128 A1
(43) Pub. Date: Jun. 26, 2025

(54) APPARATUS, METHOD AND COMPUTER PROGRAM

(71) Applicant: Nokia Technologies Oy, Espoo (FI)

(72) Inventors: Oskari TERVO, Oulu (FI); Esa Tapani TIIROLA, Oulu (FI); Ismael PERUGA NASARRE, Tampere (FI)

(21) Appl. No.: 18/848,835

(22) PCT Filed: Mar. 23, 2022
(86) PCT No.: PCT/EP2022/057583

§ 371 Date: Sep. 19, 2024

(51) Int. Cl. H04W 52/14; H04W 52/36

(52) U.S. Cl. CPC H04W 52/146; H04W 52/365; H04W 52/367

(57) ABSTRACT

An apparatus including means for, at a network, determining one of a first known sequence and at least one second known sequence based on a value of a power metric associated with the respective known sequence, providing configuration information indicative of the determined known sequence to a user equipment and receiving uplink transmission from the user equipment using the determined known sequence, wherein the uplink transmission includes a waveform including the determined known sequence, wherein the waveform is a time domain signal.

### FIELD

The present application relates to a method, apparatus, system and computer program and in particular but not exclusively to radio frequency (RF) requirements for known tail (KT) waveforms.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks and 5G-Advanced (i.e., Rel-18 and beyond). NR is being standardized by the 3rd Generation Partnership Project (3GPP).

### SUMMARY

In a first aspect there is provided an apparatus comprising means for, at a network, determining one of a first known sequence and at least one second known sequence based on a value of a power metric associated with the respective known sequence, providing configuration information indicative of the determined known sequence to a user equipment and receiving uplink transmission from the user equipment using the determined known sequence, wherein the uplink transmission comprises a waveform comprising the determined known sequence, wherein the waveform is a time domain signal.

The power metric may comprise at least one of peak to average power ratio, maximum power reduction, additional maximum power reduction and output power backoff.

The value of the power metric associated with the first known sequence may be lower than the value of the power metric associated with the at least one second known sequence.

The waveform may comprise a known tail discrete Fourier Transform spread orthogonal frequency division multiplexing waveform or a single carrier frequency domain equalization waveform.

A length of the first known sequence may be longer than a length of the at least one second known sequence.

The apparatus may comprise means for receiving information from the user equipment for use in determining the one of the first known sequence and at least one second known sequence.

The information may comprise an indication of a requested known sequence.

The apparatus may comprise means for determining one of the first known sequence and the at least one second known sequence based on a power headroom report received from the user equipment.

The first known sequence may use a first modulation and the at least one second known sequence may use a second modulation.

The apparatus may comprise means for receiving an indication from the user equipment of at least one of supported known sequence lengths, supported known sequences and supported waveform shaping.

The configuration information may comprise a parameter indicative of the known sequence length or the determined one of the first known tail sequence and the at least one second known tail sequence.

In a second aspect, there is provided an apparatus comprising means for, at a user equipment, receiving configuration information indicative of a known sequence from a network and providing uplink transmission to the network, wherein the uplink transmission comprises a waveform comprising the known sequence, wherein the waveform is a time domain signal.

The apparatus may comprise means for selecting the known sequence from a preconfigured table based on the configuration information, wherein the preconfigured table comprises at least two known sequences with different properties for at least one of power metric, sequence length and modulation.

The apparatus may comprise means for applying low-pass filtering to the known sequence.

The apparatus may comprise means for determining transmit power for the uplink transmission based on the known sequence.

The apparatus may comprise means for providing information from the user equipment to the network for use in determining one of a first known sequence and at least one second known sequence.

The information may comprise an indication of a requested known sequence.

The apparatus may comprise means for providing an indication from the user equipment to the network of at least one of supported known sequence lengths, supported known sequences and supported waveform shaping.

The known sequence may be determined by the network based on a value of a power metric associated with the known sequence.

The power metric may comprise at least one of peak to average power ratio, maximum power reduction, additional maximum power reduction and output power backoff.

The waveform may comprise a known tail discrete Fourier Transform spread orthogonal frequency division multiplexing waveform or a single carrier frequency domain equalization waveform

The configuration information may comprise a parameter indicative of the known sequence length or the determined one of the first known tail sequence and the at least one second known tail sequence.

In a third aspect there is provided a method comprising, at a network, determining one of a first known sequence and at least one second known sequence based on a value of a power metric associated with the respective known sequence, providing configuration information indicative of the determined known sequence to a user equipment and receiving uplink transmission from the user equipment using the determined known sequence, wherein the uplink transmission comprises a waveform comprising the determined known sequence, wherein the waveform is a time domain signal.

The power metric may comprise at least one of peak to average power ratio, maximum power reduction, additional maximum power reduction and output power backoff.

The value of the power metric associated with the first known sequence may be lower than the value of the power metric associated with the at least one second known sequence.

The waveform may comprise a known tail discrete Fourier Transform spread orthogonal frequency division multiplexing waveform or a single carrier frequency domain equalization waveform.

A length of the first known sequence may be longer than a length of the at least one second known sequence.

The method may comprise receiving information from the user equipment for use in determining the one of the first known sequence and at least one second known sequence.

The information may comprise an indication of a requested known sequence.

The method may comprise determining one of the first known sequence and the at least one second known sequence based on a power headroom report received from the user equipment.

The first known sequence may use a first modulation and the at least one second known sequence may use a second modulation.

The method may comprise receiving an indication from the user equipment of at least one of supported known sequence lengths, supported known sequences and supported waveform shaping.

The configuration information may comprise a parameter indicative of the known sequence length or the determined one of the first known tail sequence and the at least one second known tail sequence.

In a fourth aspect there is provided a method comprising, at a user equipment, receiving configuration information indicative of a known sequence from a network and providing uplink transmission to the network, wherein the uplink transmission comprises a waveform comprising the known sequence, wherein the waveform is a time domain signal.

The method may comprise selecting the known sequence from a preconfigured table based on the configuration information, wherein the preconfigured table comprises at least two known sequences with different properties for at least one of power metric, sequence length and modulation.

The method may comprise applying low-pass filtering to the known sequence.

The method may comprise determining transmit power for the uplink transmission based on the known sequence.

The method may comprise providing information from the user equipment to the network for use in determining one of a first known sequence and at least one second known sequence.

The information may comprise an indication of a requested known sequence.

The method may comprise providing an indication from the user equipment to the network of at least one of supported known sequence lengths, supported known sequences and supported waveform shaping.

The known sequence may be determined by the network based on a value of a power metric associated with the known sequence.

The power metric may comprise at least one of peak to average power ratio, maximum power reduction, additional maximum power reduction and output power backoff.

The waveform may comprise a known tail discrete Fourier Transform spread orthogonal frequency division multiplexing waveform or a single carrier frequency domain equalization waveform

The configuration information may comprise a parameter indicative of the known sequence length or the determined one of the first known tail sequence and the at least one second known tail sequence.

In a fifth aspect there is provided an apparatus comprising: at least one processor and at least one memory including a computer program code, the at least one memory and computer program code configured to, with the at least one processor, cause the apparatus at least to: determine one of a first known sequence and at least one second known sequence based on a value of a power metric associated with the respective known sequence, provide configuration information indicative of the determined known sequence to a user equipment and receive uplink transmission from the user equipment using the determined known sequence, wherein the uplink transmission comprises a waveform comprising the determined known sequence, wherein the waveform is a time domain signal.

The power metric may comprise at least one of peak to average power ratio, maximum power reduction, additional maximum power reduction and output power backoff.

The value of the power metric associated with the first known sequence may be lower than the value of the power metric associated with the at least one second known sequence.

The waveform may comprise a known tail discrete Fourier Transform spread orthogonal frequency division multiplexing waveform or a single carrier frequency domain equalization waveform.

A length of the first known sequence may be longer than a length of the at least one second known sequence.

The apparatus may be configured to receive information from the user equipment for use in determining the one of the first known sequence and at least one second known sequence.

The information may comprise an indication of a requested known sequence.

The apparatus may be configured to determine one of the first known sequence and the at least one second known sequence based on a power headroom report received from the user equipment.

The first known sequence may use a first modulation and the at least one second known sequence may use a second modulation.

The apparatus may be configured to receive an indication from the user equipment of at least one of supported known sequence lengths, supported known sequences and supported waveform shaping.

The configuration information may comprise a parameter indicative of the known sequence length or the determined one of the first known tail sequence and the at least one second known tail sequence.

In a sixth aspect there is provided an apparatus comprising: at least one processor and at least one memory including a computer program code, the at least one memory and computer program code configured to, with the at least one processor, cause the apparatus at least to: receive configuration information indicative of a known sequence from a network and provide uplink transmission to the network, wherein the uplink transmission comprises a waveform comprising the known sequence, wherein the waveform is a time domain signal.

The apparatus may be configured to select the known sequence from a preconfigured table based on the configuration information, wherein the preconfigured table comprises at least two known sequences with different properties for at least one of power metric, sequence length and modulation.

The apparatus may be configured to apply low-pass filtering to the known sequence.

The apparatus may be configured to determine transmit power for the uplink transmission based on the known sequence.

The apparatus may be configured to determine information from the user equipment to the network for use in determining one of a first known sequence and at least one second known sequence.

The information may comprise an indication of a requested known sequence.

The apparatus may be configured to provide an indication from the user equipment to the network of at least one of supported known sequence lengths, supported known sequences and supported waveform shaping.

The known sequence may be determined by the network based on a value of a power metric associated with the known sequence.

The power metric may comprise at least one of peak to average power ratio, maximum power reduction, additional maximum power reduction and output power backoff.

The waveform may comprise a known tail discrete Fourier Transform spread orthogonal frequency division multiplexing waveform or a single carrier frequency domain equalization waveform

The configuration information may comprise a parameter indicative of the known sequence length or the determined one of the first known tail sequence and the at least one second known tail sequence.

In a seventh aspect there is provided a computer readable medium comprising program instructions for causing an apparatus to perform at least the following at a network, determining one of a first known sequence and at least one second known sequence based on a value of a power metric associated with the respective known sequence, providing configuration information indicative of the determined known sequence to a user equipment and receiving uplink transmission from the user equipment using the determined known sequence, wherein the uplink transmission comprises a waveform comprising the determined known sequence, wherein the waveform is a time domain signal.

The power metric may comprise at least one of peak to average power ratio, maximum power reduction, additional maximum power reduction and output power backoff.

The value of the power metric associated with the first known sequence may be lower than the value of the power metric associated with the at least one second known sequence.

The waveform may comprise a known tail discrete Fourier Transform spread orthogonal frequency division multiplexing waveform or a single carrier frequency domain equalization waveform.

A length of the first known sequence may be longer than a length of the at least one second known sequence.

The apparatus may be caused to perform receiving information from the user equipment for use in determining the one of the first known sequence and at least one second known sequence.

The information may comprise an indication of a requested known sequence.

The apparatus may be caused to perform determining one of the first known sequence and the at least one second known sequence based on a power headroom report received from the user equipment.

The first known sequence may use a first modulation and the at least one second known sequence may use a second modulation.

The apparatus may be caused to perform receiving an indication from the user equipment of at least one of supported known sequence lengths, supported known sequences and supported waveform shaping.

The configuration information may comprise a parameter indicative of the known sequence length or the determined one of the first known tail sequence and the at least one second known tail sequence.

In an eighth aspect there is provided a computer readable medium comprising program instructions for causing an apparatus to perform at least the following at a user equipment, receiving configuration information indicative of a known sequence from a network and providing uplink transmission to the network, wherein the uplink transmission comprises a waveform comprising the known sequence, wherein the waveform is a time domain signal.

The apparatus may be caused to perform selecting the determined known sequence from a preconfigured table based on the configuration information, wherein the preconfigured table comprises at least two known sequences with different properties for at least one of power metric, sequence length and modulation.

The apparatus may be caused to perform applying low-pass filtering to the known sequence.

The apparatus may be caused to perform determining transmit power for the uplink transmission based on the known sequence.

The apparatus may be caused to perform providing information from the user equipment to the network for use in determining one of a first known sequence and at least one second known sequence.

The information may comprise an indication of a requested known sequence.

The apparatus may be caused to perform providing an indication from the user equipment to the network of at least one of supported known sequence lengths, supported known sequences and supported waveform shaping.

The known sequence may be determined by the network based on a value of a power metric associated with the known sequence.

The power metric may comprise at least one of peak to average power ratio, maximum power reduction, additional maximum power reduction and output power backoff.

The waveform may comprise a known tail discrete Fourier Transform spread orthogonal frequency division multiplexing waveform or a single carrier frequency domain equalization waveform

The configuration information may comprise a parameter indicative of the known sequence length or the determined one of the first known tail sequence and the at least one second known tail sequence.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a sub-THz spectrum overview;

FIG. 5a shows a schematic diagram of a DFT-s-OFDM symbol structure;

FIG. 5b shows a schematic diagram of a KT-DFT-s-OFDM symbol structure;

FIG. 6 shows a block diagram of a KT-DFT-s-OFDM modulator;

FIG. 7 shows a flowchart of a method according to an example embodiment;

FIG. 8 shows a flowchart of a method according to an example embodiment;

FIG. 9 shows an example PHR mapping table for determining KT sequence length with a threshold;

FIG. 10 shows a signalling flow diagram according to an example embodiment;

FIG. 11a shows OBO of the KT-DTF-s-OFDM as a function of KT sequence length and allocation size with [1+D]PI/2-BPSK KT sequence for QPSK;

FIG. 11b shows OBO of the KT-DTF-s-OFDM as a function of KT sequence length and allocation size with [1+D]PI/2-BPSK KT sequence for 16QAM;

FIG. 11c shows OBO of the KT-DTF-s-OFDM as a function of KT sequence length and allocation size with [1+D]PI/2-BPSK KT sequence for 64QAM;

FIG. 12 shows OBO of the KT-DTF-s-OFDM as a function of KT sequence length and allocation size with ZC as KT sequence for QPSK.

### DETAILED DESCRIPTION

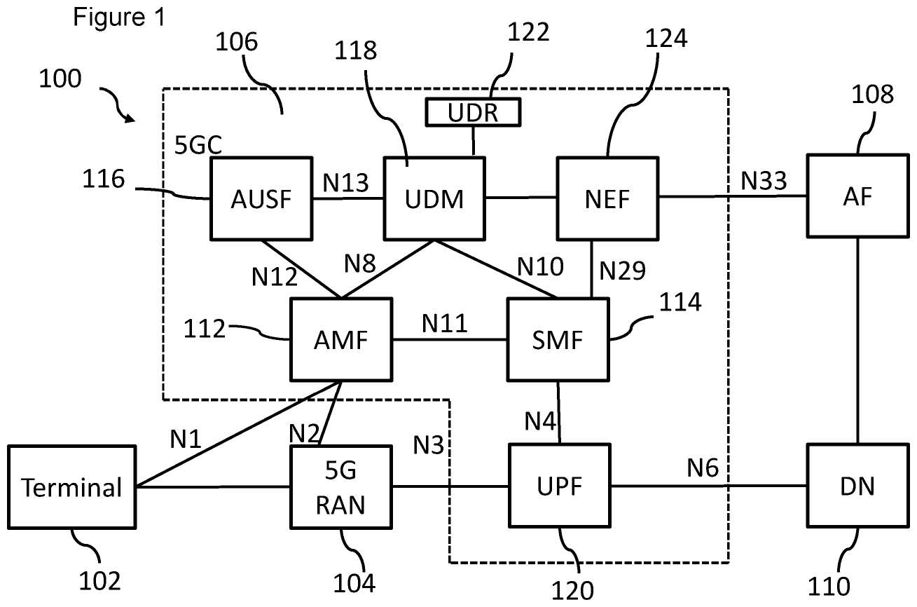

Before explaining in detail the examples, certain general principles of a wireless communication system and mobile communication devices are briefly explained with reference to FIGS. 1 to 3 to assist in understanding the technology underlying the described examples.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. Quality of Service (QOS) levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

An example 5G core network (CN) comprises functional entities. The CN is connected to a UE via the radio access network (RAN). The UPF 120 as PDU Session Anchor (PSA) may be responsible for forwarding frames back and forth between the DN 110 and the tunnels established over the 5G towards the UE(s) exchanging traffic with the DN 110.

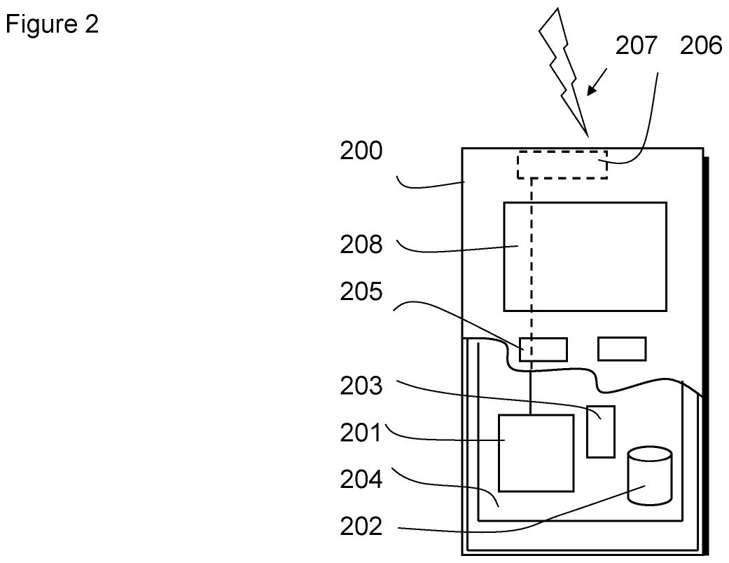

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

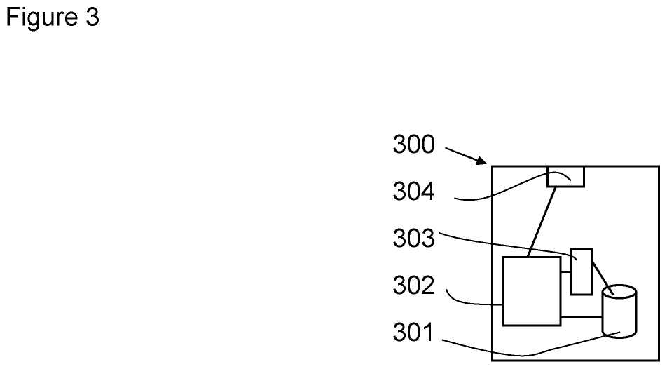

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. A relay node may be a node in an Integrated Access and Backhaul (IAB) scenario. The mobile termination (MT) part of an IAB node performs the UE functionalities (in other words, it facilitates the backhaul link). The DU part of IAB node performs the gNB functionalities (in other words it facilitates the access link).

3GPP Rel-17 supports CP-OFDM (Cyclic Prefix Orthogonal Frequency Division Multiplexing) in downlink (DL), and both CP-OFDM and (single-carrier waveform) DFT-s-OFDM (Discrete Fourier Transform spread Orthogonal Frequency Division Multiplexing) in uplink (UL). Currently, 3GPP is standardizing support for FR2-2, i.e., frequencies 52.6-71 GHZ, in Rel-17. The main scenario is unlicensed band operation with relatively low Effective Isotropic Radiated Power (EIRP) (40 dBm). 40 dBm is a typical EIRP value for a gNB/Access Point. Regulations may allow a higher EIRP, e.g., up to 60 dBm for certain scenarios (such as licensed band and/or fixed link).

In Rel-19 and beyond, frequencies above 71 GHz may be considered. One aspect will be to consider single-carrier waveforms both in uplink and downlink, Single carrier waveforms may allow a higher EIRP (e.g. 60 dBm) with smaller power amplifier (PA) output backoff. That is, single carrier waveforms may reduce cost and complexity of the hardware and/or power consumption. Single-carrier waveforms may be more robust to phase noise with low complexity.

Power backoff in an amplifier is a power reduction below the saturation point of amplifier to enable the amplifier to operate in the linear region even if there is a slight increase in the input power level. Usually, power amplifiers operate close to the saturation point where efficiency is maximum. However, at this point, a small increase in input power can push the amplifier from the linear mode to the saturated mode. Thus, to ensure the amplifier operates in the linear region, the power level is lowered from the point of maximum efficiency. The value of this power level reduction is known as Power Backoff. The higher the power backoff, the smaller the actual transmit power and coverage.

The power backoff is used because the input power level is not constant over time, but varies. This variation may be characterized by peak-to-average power ratio (PAPR). The higher the PAPR, the more there are variations in the input power levels, which means that more power backoff is required to ensure the operation in the linear region. PAPR varies with the modulation scheme for single-carrier waveforms. Lower-order modulations have lower PAPR, and thus require smaller power backoff. The specification defines maximum power reduction (MPR) values for each modulation, which is the allowed reduction of maximum power level (power backoff) which a UE can use for a given modulation. Table 1 shows (Table 6.2.2.1-1 TS 38.101-2) shows an example MPR for FR2-1 scenario. FR2-1 corresponds to mmWave scenarios below 52.6 GHz.

$$MPR = max ( {MPR}_{WT} , MP {R}_{narrow} ) , where$$

$$MP {R}_{narrow} = 14.4 dB , when {BW}_{alloc , RB} \leq 1.44 MHz , M P {R}_{narrow} = 10 dB , when 1.44 MHz < {B}_{Walloc , RB} \leq 10.8 MHz , where {BW}_{alloc , RB} is the bandwidth of the RB allocation size .$$

TABLE 1
Table 6.2.2.1-1: MPR_{WT} for power class 1, BW_{channel} ≤ 200 MHz

| | | MPR_{WT} (dB), BW_{channel} ≤ 200 MHz | | |
|---|---|---|---|---|
| | | Outer RB | Inner RB allocations | |
| Modulation | | allocations | Region 1 | Region 2 |
| DFT-s-OFDM | Pi/2 BPSK | ≤5.5 | 0.0 | ≤3.0 |
| | QPSK | ≤6.5 | 0.0 | ≤3.0 |
| | 16 QAM | ≤6.5 | ≤4.0 | ≤4.0 |
| | 64 QAM | ≤6.5 | ≤5.0 | ≤5.0 |
| CP-OFDM | QPSK | ≤7.0 | ≤4.5 | ≤4.5 |
| | 16 QAM | ≤7.0 | ≤5.5 | ≤5.5 |
| | 64 QAM | ≤7.5 | ≤7.5 | ≤7.5 |

Power amplifier (PA) efficiency decreases as the backoff is increased. This will become increasingly important in the sub-THz systems. It may lead to large power consumption, either a larger power amplifier is selected in the design, or transmission times increase for the same amount of data due to lower spectral efficiency. Techniques to reduce backoff, to enable lower power consumption and improved coverage are thus of interest.

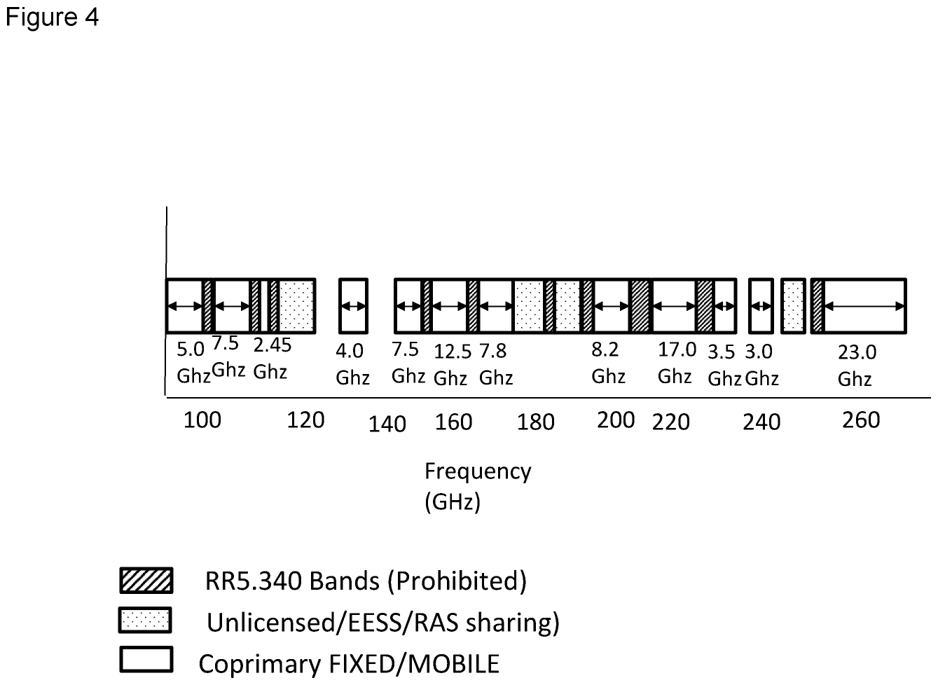

Single-carrier waveform study for >71 GHz has been proposed. The frequency bands in this region include, e.g., W-band (75 to 110 GHZ) and D-band (110 to 170 GHZ), as shown in FIG. 4. It can be seen that the amount of spectrum is high, but there are also restrictions for the band usage, such as RR5.340 where all emissions are prohibited (passive satellite band).

European telecommunications regulator CEPT ECC has approved two recommendations for Fixed Service (FS) above 92 GHZ.
W Band ECC Recommendation ECC/REC/(18)02 on frequencies 92-114.25 GHZ (link).
D Band ECC Recommendation ECC/REC/(18)01 on frequencies 130-174.8 GHZ (link).

One waveform candidate for these higher frequencies is Known Tail DFT-s-OFDM (KT-DFT-s-OFDM), which is quite similar to DFT-s-OFDM as defined for LTE UL (and supported by 5G New Radio UL). KT-DFT-s-OFDM is also referred to as Unique Word (UW) DFT-s-OFDM.

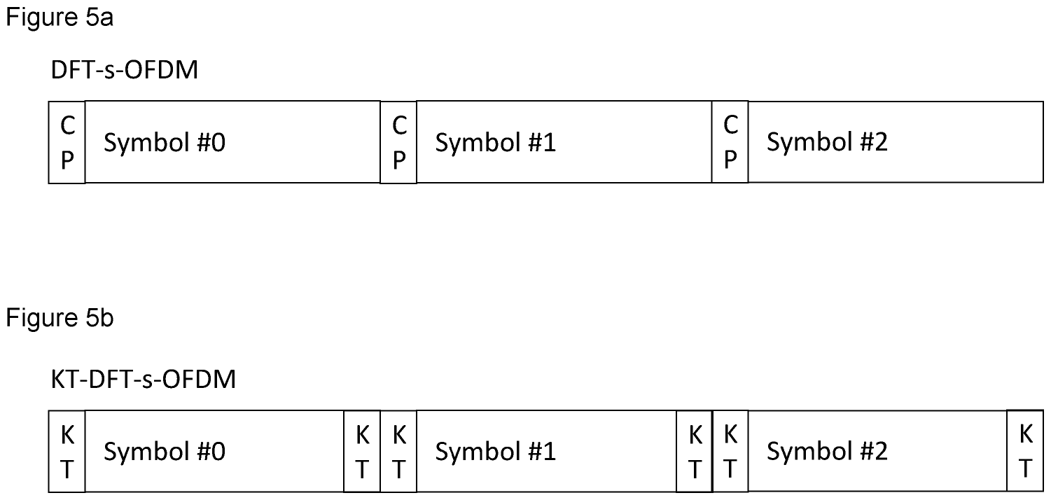

FIG. 5a shows a DFT-s-OFDM symbol structure. In DFT-s-OFDM, the CP overhead is fixed and the symbol is extended by it (after the inverse fast Fourier transform (IFFT)).

FIG. 5b shows a KT-DFT-s-OFDM symbol structure.

In KT-DFT-s-OFDM, there is a known sequence (referred to as a Known Tail (KT) sequence) in the end of a symbol (KT-tail) and the beginning of the symbol (KT-head). The KT sequences are inserted before DFT. The length of the KT sequence may be adjusted. KT-head and KT-tail may have the same or different lengths. The term known tail sequence may refer to at least one of KT-head and KT-tail. KT sequence length refers to the length of the head and/or tail sequence separately. In addition, there is no extra guard interval between the symbols.

The main difference between DFT-s-OFDM and KT-DFT-s-OFDM is that DFT-s-OFDM uses cyclic prefix (CP) to handle the delay spread, while in KT-DFT-s-OFDM, the cyclic prefix is replaced by in-symbol known sequence in the beginning and end of the symbol, inserted prior to discrete Fourier transform (DFT). A waveform may also be a combination of these two waveforms, where a known tail sequence is used in addition to cyclic prefix, and the proposed method may also be applied in such waveform.

Adjustable KT sequence length (in other words, the number of symbols used for the head and/or tail of a KT-DFT-s-OFDM symbol) may provide optimized spectrum efficiency, depending on the case. KT symbols may also provide reduced PAPR since the KT sequences may be designed to have near-to-constant envelope, providing increased transmit power (cyclic prefix creates phase/amplitude discontinuity, which may have a negative impact to spectral properties of the signal). Removing the CP may also provide improved spectral containment performance. PAPR may also be reduced by using spectrum shaping techniques such as frequency-domain spectrum shaping (FDSS) or FDSS with spectrum extension. 15-symbol slots, compared to conventional 14-symbol slots as used in 5G New Radio may be used. KT sequences may be used for channel estimation and phase noise estimation, providing improved performance.

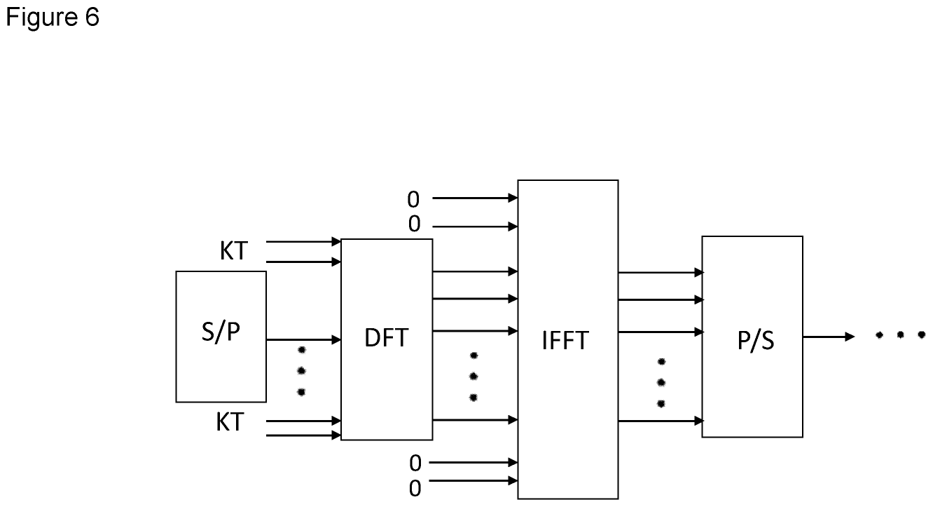

FIG. 6 shows an example block diagram of a KT-DFT-s-OFDM modulator. The KT sequence is added to at least one of the head and tail of a block of a modulation symbols before DFT operation, and then DFT operation is performed, followed by subcarrier mapping and IFFT operation and parallel-to-serial conversion, forming a single-carrier symbol (e.g., KT-DFT-s-OFDM symbol). The modulation symbols in addition to KT sequence(s) within a single-carrier symbol may be e.g., data symbols or control symbols.

It is noted that a time-domain generation of the waveform is equally possible, following a Single-Carrier Frequency Domain Equalization (SC-FDE) transmission scheme. This type of transmission, including known sequences at the beginning and/or end of the SC-FDE block, is followed by IEEE 802.11ad standard. Thus, embodiments described in this document may also be applied to SC-FDE waveform.

The Error Vector Magnitude (EVM) is a measure of the difference between the reference waveform and the measured waveform. Table 2 (Table 6.4.2.1-1 TS 38.101-2) shows the exiting EVM requirements for NR UE (FR2).

TABLE 2
Table 6.4.2.1-1: Minimum requirements for error vector magnitude

| | | Average | Reference signal |
|---|---|---|---|
| Parameter | Unit | EVM level | EVM level |
| Pi/2 BPSK | % | 30.0 | 30.0 |
| QPSK | % | 17.5 | 17.5 |
| 16 QAM | % | 12.5 | 12.5 |
| 64 QAM | % | 8.0 | 8.0 |

The in-band emission is defined as the average emission across 12 sub-carriers and as a function of the RB offset from the edge of the allocated UL transmission bandwidth. The in-band emission is measured as the ratio of the UE output power in a non-allocated RB to the UE output power in an allocated RB.

Table 3 (Table 6.4A.2.3-1 TS 38.101-2) shows the current IBE requirements for NR UE (FR2).

TABLE 3
|Table 6.4A.2.3.2-1 Requirements for in-band emissionsfor power class 1

| Parameter | | | | Applicable |
|---|---|---|---|---|
| description | Unit | Limit (NOTE 1) | | Frequencies |
| General | dB | $max [ \begin{matrix}- 25 - 10 \cdot {log}_{10} ( \frac{{N}_{RB}}{{L}_{CRB}} ) , \\ 20 \cdot {log}_{10} ( EVM ) - 5 \cdot \frac{( \vert {Δ}_{RB} \vert - 1 )}{{L}_{CRB}} , \\ - 55.1 dBm - {P}_{RB}\end{matrix} ]$ | | Any non-allocated RB in allocated component carrier and not allocated component carriers (NOTE 2) |
| IQ Image | dB | −25 | Output power > 27 dBm | Image frequencies |
| | | −20 | Output power ≤ 27 dBm | (NOTES 2, 3) |
| Carrier | dBc | −25 | Output power > 17 dBm | Carrier frequency |
| leakage | | −20 | 4 dBm ≤ Output power ≤ 17 dBm | (NOTES 4, 5) |

NOTE 1:
An in-band emissions combined limit is evaluated in each non-allocated RB. For each such RB, the minimum requirement is calculated as the higher of (P_{AB} - 25 dB) and the power sum of all limit values (General, IQ Image or Carrier leakage) that apply. P_{RB} is defined in NOTE 9.
NOTE 2:
The measurement bandwidth is 1 RB and the limit is expressed as a ratio of measured power in one non-allocated RB to the measured average power per allocated RB, where the averaging is done across all allocated RBs. For Pi/2 BPSK with Spectrum Shaping, the limit is expressed as a ratio of measured power in one non-allocated RB to the measured power in the allocated RB with highest PSD.
NOTE 3:
Image frequencies for UL CA are specified in relation to either UL or DL carrier frequency.
NOTE 4:
The measurement bandwidth is 1 RB and the limit is expressed as a ratio of measured power in one non-allocated RB to the measured total power in all allocated RBs.
NOTE 5:
The applicable frequencies for this limit are those that are enclosed in the RBs containing the DC frequency, or in the two RBs immediately adjacent to the DC frequency but excluding any allocated RB.
NOTE 6:
L_{CRB} is the Transmission Bandwidth for kth allocated component carrier (see Figure 5.3.3-1).
NOTE 7:
EVM s the limit for the modulation format used in the allocated RBs.
NOTE 8:
Δ_{RB} is the starting frequency offset between the allocated RB and the measured non-allocated RB (e.g. Δ_{RB} = 1 or
Δ_{RB} = −1 for the first adjacent RB outside of the allocated bandwidth), and may take non-integer values when the carrier spacing between the CCs is not a multiple of RB.
NOTE 9:
P_{RB} is the transmitted power per allocated RB, measured in dBm.
NOTE 10:
All powers are EIRP in beam peak direction.

Occupied bandwidth is defined as the bandwidth containing 99% of the total integrated mean power of the transmitted spectrum on the assigned channel. The occupied bandwidth for all transmission bandwidth configurations (Resources Blocks) shall be less than the channel bandwidth specified in Table 4 (Table 6.5.1-1 TS 38.101-2)

TABLE 4
Table 6.5.1-1: Occupied channel bandwidth

| | Occupied channel bandwidth/Channel bandwidth | | | |
|---|---|---|---|---|
| | 50 | 100 | 200 | 400 |
| | MHz | MHz | MHz | MHz |
| Channel bandwidth | 50 | 100 | 200 | 400 |
| (MHz) | | | | |

The spectrum emission mask of the UE applies to frequencies (Δf_{OOB}) starting from the ± edge of the assigned NR channel bandwidth. For frequency offset greater than F_{OOB} as specified in Table 5 (Table 6.5.2.1-1 TS 38.101-2), the spurious requirements in clause 6.5.3 are applicable.

TABLE 5
Table 6.5.2.1-1: General NR spectrum emission mask for
frequency range 2.
Spectrum emission limit (dBm)/Channel bandwidth

| Δf_{OOB} | 50 | 100 | 200 | 400 | Measurement |
|---|---|---|---|---|---|
| (MHz) | MHz | MHz | MHz | MHz | bandwidth |
| ±0-5 | −5 | −5 | −5 | −5 | 1 MHz |
| ±5-10 | −13 | −5 | −5 | −5 | 1 MHz |
| ±10-20 | −13 | −13 | −5 | −5 | 1 MHz |
| ±20-40 | −13 | −13 | −13 | −5 | 1 MHz |
| ±40-100 | −13 | −13 | −13 | −13 | 1 MHz |
| ±100-200 | | −13 | −13 | −13 | 1 MHz |
| ±200-400 | | | −13 | −13 | 1 MHz |
| ±400-800 | | | | −13 | 1 MHz |

NOTE 1:
Void

When KT-DFT-s-OFDM is considered for standardization, the design will be different from currently supported waveforms (CP-OFDM and DFT-s-OFDM) because the cyclic prefix will be removed and replaced by an in-symbol known sequence in the head (and/or tail) of the symbol. To provide maximum benefits of the waveform, the length of the known sequence(s) may be configurable. For example, KT sequence length in pre-DFT symbols may be 4, 16, 64, 128, or 256.

In practice, changing the KT sequence length affects the properties of the signal such as Peak To Average Power Ratio (PAPR), and thus it may be exploited when choosing e.g. the KT sequence and sequence length. A signal having lower PAPR means that the power amplifier requires smaller output power backoff, meaning that a higher transmit power can be achieved, providing, for example, larger coverage. Also, the RF requirements may be designed accordingly.

In the current specification, there are different MPR requirements depending on the modulation and allocation, as e.g., shown in Table 1 above. This may be seen as a baseline, i.e., defining RF requirements such as MPR according to modulation order, waveform and PRB allocation. This approach may not fully exploit the potential of KT-DFT-s-OFDM waveform for increasing the Tx power.

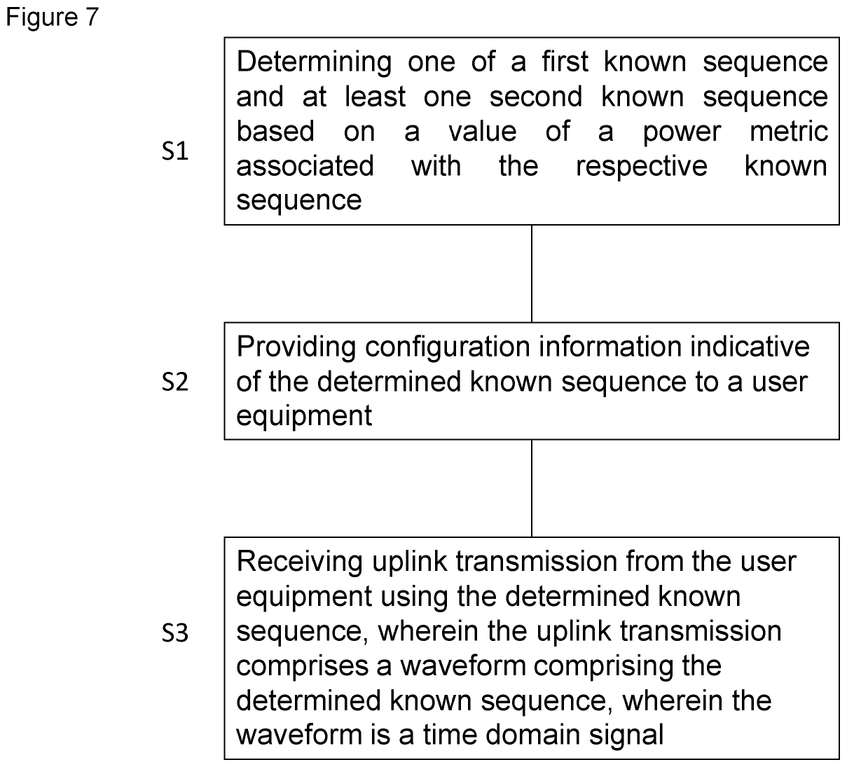

FIG. 7 shows a flowchart of a method according to an example embodiment. The method may be performed at a network node, such as a gNB.

In S1, the method comprises determining one of a first known sequence and at least one second known sequence based on a value of a power metric associated with the respective known sequence.

In S2, the method comprises providing configuration information indicative of the determined known sequence to a user equipment.

In S3, the method comprises receiving uplink transmission from the user equipment using the determined known sequence, wherein the uplink transmission comprises a waveform comprising the determined known sequence, wherein the waveform is a time domain signal.

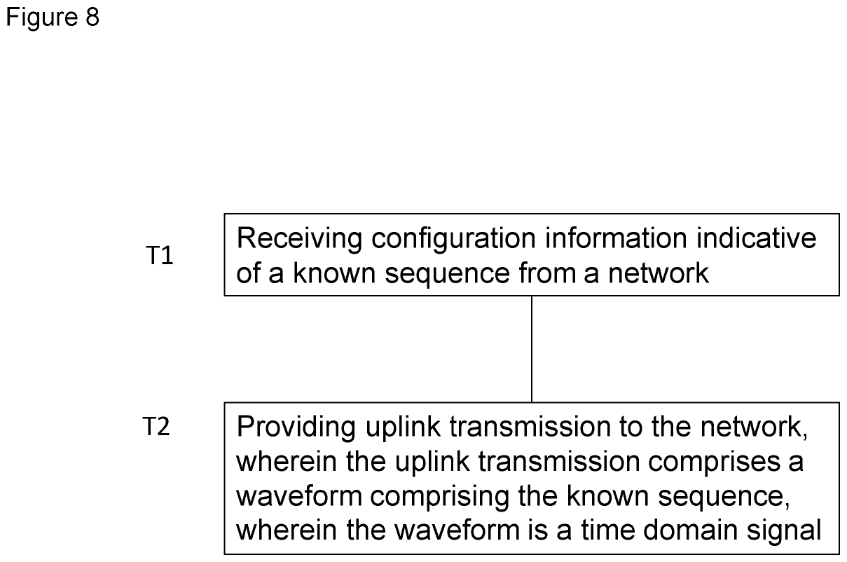

FIG. 8 shows a flowchart of a method according to an example embodiment. The method may be performed at a user equipment.

In T1, the method comprises receiving configuration information indicative of a known sequence from a network.

In T2, the method comprises providing uplink transmission to the network, wherein the uplink transmission comprises a waveform comprising the known sequence, wherein the waveform is a time domain signal.

The power metric may comprise at least one of PAPR, MPR, Additional Maximum Power Reduction (A-MPR) and OBO. The OBO, MPR and A-MPR may be dependent on the PAPR of a waveform.

The value of the power metric associated with the first known sequence may be lower than that of the at least one second known sequence.

The waveform may comprise a KT-DFT-s-OFDM waveform or a SC-FDE waveform.

In an example embodiment, a gNB determines a first or second KT sequence, wherein a first KT sequence has a lower PAPR than a second KT sequence and provides configuration information to a UE indicating the first or second KT sequence.

In addition, gNB may use other information such as the delay spread of the channel when determining the sequence.

The configuration information may comprise a parameter indicative indication of known tail sequence length or an indication of the determined one of the first known sequence and the at least one second known sequence. The UE may select the determined known sequence based on the indication. The UE may select the determined known sequence from a preconfigured table based on the configuration information. The preconfigured table may comprise at least two known sequences with different properties for at least one of power metric, sequence length and modulation.

Determining the known sequence at the network may be based on preconfigured (e.g., specification) tables.

The configuration information may be received during RRC configuration. The configuration information may be received in DCI or MAC based control message during a connection (that is, following connection establishment). In the case of semi-persistent transmission, the configuration information may be provided during RRC reconfiguration.

The method may comprise receiving information at the network from the user equipment for use in determining the one of the first known sequence and at least one second known sequence. The information may be a PHR. The information may be any other indication of a desired known sequence (in other words, a requested known sequence) since the UE may have the best information of its current transmit power capabilities in a dynamic environment.

Determining one of a first known sequence and at least one second known sequence at the network may be based on a power headroom report (PHR). In an example embodiment, a shorter KT sequence is selected when the PHR is greater than a threshold. PHR may also be defined based on KT sequence lengths.

Power Headroom Report (PHR) indicates how much power headroom the UE still has available compared to the current Physical Uplink Shared Channel (PUSCH) power, i.e., defined as PHR=P_max−P_PUSCH, where P_max is UEs max TX power, and P_PUSCH is current PUSCH power, and PHR is indicated in 1 dB granularity.

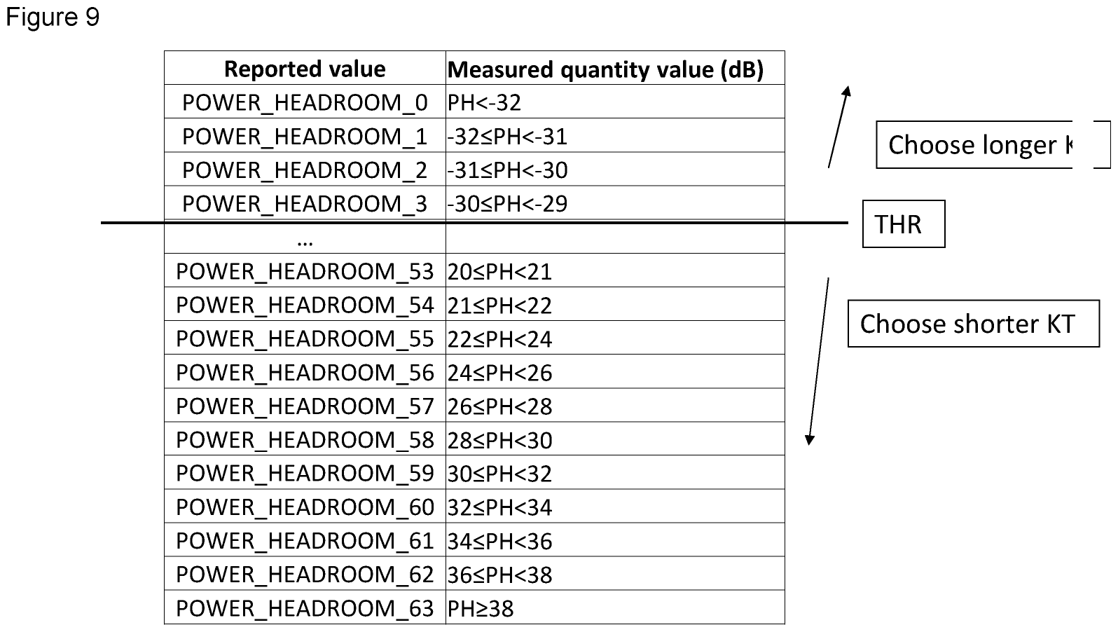

FIG. 9 shows an example PHR mapping table. If a UE reports e.g., POWER_HEADROOM_3, which means that there is less power headroom than a threshold index, then the network determines to use a longer known sequence length to be able to increase the TX power compared, for example, to the current known sequence length.

The PHR can be defined based on current known sequence length. The UE may also indicate its P_MAX for different known sequence lengths to the network. The threshold index may be indicated from the UE to the gNB.

Alternatively, the PHR may be defined based on a predefined (e.g. longest) known sequence length (i.e. known sequence length with the max power).

The first known sequence may use a first modulation and the at least one second known sequence may use a second modulation. Different modulations may have different properties that could be useful for different scenarios.

For example, the first modulation may be pi/2-BPSK and the second modulation may be Zadoff-Chu sequences. Zadoff-Chu sequences result in higher PAPR for KT-DFT-s-OFDM if it is used for KT sequence, but it has, e.g., good synchronization properties. pi/2-BPSK results in low PAPR for the KT-DFT-s-OFDM, even more when low-pass filtering is applied for the sequence.

The method may comprise, at the user equipment, applying low pass filtering to the determined known sequence.

In an example embodiment, a first KT sequence may be filtered using a low-pass filter and a second KT sequence may be unfiltered.

The low-pass filter may be, e.g., 1+D filter (corresponding to a 2-tap FIR filter with taps [1 1]/C, where C is a normalization factor). The low-pass filter may be directly applied to the KT sequence before the DFT stage of the transmitter.

In an example embodiment, if frequency-domain spectral shaping is applied to the whole transmission, the KT sequence would not need to be filtered separated to the data.

The first known sequence may be longer than the at least one second known sequence. When the PAPR of the modulation of the KT sequence is lower than the PAPR of the modulation that carries the data (for example, when KT sequence is [1+D]PI/2-BPSK and data is QPSK or 16/64-QAM) the longer the KT sequence, the lower the PAPR of the symbol.

The method may comprise determining transmit power at the user equipment for the uplink transmission based on the determined known sequence. Determining transmit power may comprise determining the maximum transmission (Max Tx) power or the MPR (compared to a predefined reference, e.g. 23 dBm).

The first known sequence may have a lower MPR or A-MPR requirement than the at least one second known sequence. Known sequence length-specific MPR may be separately defined for different modulation schemes, and PRB allocations.

The specification may define similar tables as Table 1 depending on the factors for MPR values, or define specific MPR offset values which would depend on those factors.

One option is to define separate table for each KT sequence length (and/or KT sequence, and/or KT power scaling).

Another variant is to define MPR tables based on a threshold, e.g., for KT sequence length larger than a threshold use MPR1, and KT sequence length smaller than a threshold use MPR2 (for power scaling respectively).

A UE may determine which MPR table to follow based on at least one of default configuration, higher layer signalling received via gNB and dynamic signalling received from gNB (where UE is configured with more than one KT sequence length).

The MPR requirement for the waveform may be defined based on the applied known sequence, and/or the related pulse shaping/spectrum shaping. This allows further reduction of the OBO (and thus potential for smaller MPR).

The properties of the KT sequence can also be configurable (by gNB) depending on scenario. For example, the KT sequence may serve as Demodulation Reference signal (DMRS)/phase Tracking Reference Signal (PTRS) for PUSCH detection. This may require less aggressive filtering and a larger MPR. There may be an MPR table for the case when KT sequences serve as DMRS/PTRS.

A gNB may configure separate DMRS/PTRS for PUSCH detection. Requiring more aggressive filtering, leading to a smaller MPR. In this scenario, the properties of KT sequence can be left (at least partially) for UE implementation. There may be an MPR table for the case when separate DMRS/PTRS are configured.

Power scaling is one degree of freedom when adjusting the properties of the KT sequence. Power scaling means that the KT sequences can be scaled to have the same mean power as the data sequences, more power than the data sequence, or less power than the data sequence. KT power scaling may be predefined and/or configured by a gNB (or defined by a UE). There is a trade-off between ‘usefulness’ of the KT for estimation and output backoff.

The method may comprise providing an indication to the network from the user equipment of at least one of supported known sequence lengths, supported known tail sequences and supported waveform shaping. In an example embodiment, UE supports only a predefined set of known sequence lengths. A UE may inform the set of supported known lengths by capability signalling. A UE may operate according to default known length when the RRC connection has not been established. Another option is to use (legacy) waveforms in these cases.

In an example embodiment, a UE is configured by a certain length of the KT sequence, modulation, and frequency domain resource allocation, and scheduled for transmitting PUSCH in UL. The KT sequence length and modulation is determined according to PAPR, and may be based on PHR.

Alternatively, a UE is configured according to certain length of KT, and frequency domain resource allocation, and scheduled for PUSCH. Based on the KT sequence length, UE may determine the desired KT sequence to use.

In these examples, the UE determines whether to apply low-pass filtering or not. The UE then adjusts its transmit power according to KT sequence length and sequence. The UE transmits PUSCH using the determined KT sequence length, sequence and modulation. The longer the KT sequence, the higher the TX power may be.

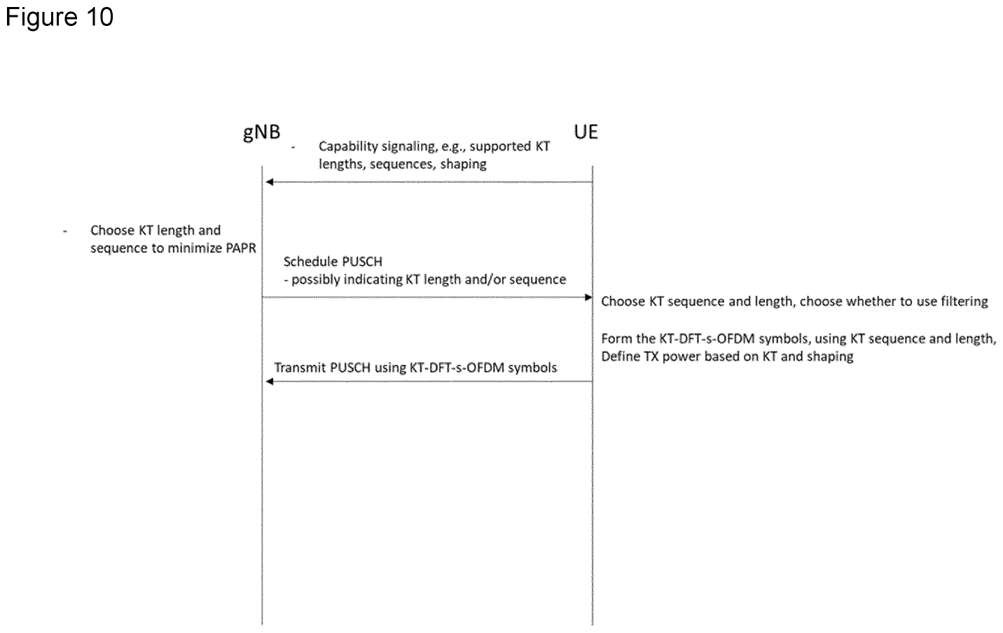

FIG. 10 shows a signalling diagram between a UE and a gNB according to an example embodiment. The UE provides capability signalling, e.g., supported KT sequence lengths, sequences and shaping to a gNB.

The gNB schedules PUSCH for the UE. The gNB determines KT sequence length and sequence to minimise PAPR. The gNB may indicate KT sequence length and/or KT sequence in the configuration information.

Alternatively, the UE may select the determined KT sequence and sequence length based on the configuration information. The UE may determine whether to use filtering.

The UE forms the KT-DFT-s-OFDM symbols, using the determined KT sequence and sequence length. The UE determines TX power based on the KT and formed KT-DFT-s-OFDM symbols.

The UE transmits PUSCH using the KT-DFT-s-OFDM symbols and determined TX power.

Configuring the KT sequence length and sequence may achieve low-PAPR. KT sequence length and sequence impacts significantly on the achieved output power. Different sequences may also have different desirable properties, such as synchronization properties, and so the sequence is adjustable for different scenarios.

The method allows the benefits of KT waveform to be realised. The method may provide optimized coverage, providing significant performance benefits. The method may provide improved performance compared to DFT-s-OFDM, with case optimized trade-off between KT overhead and coverage.

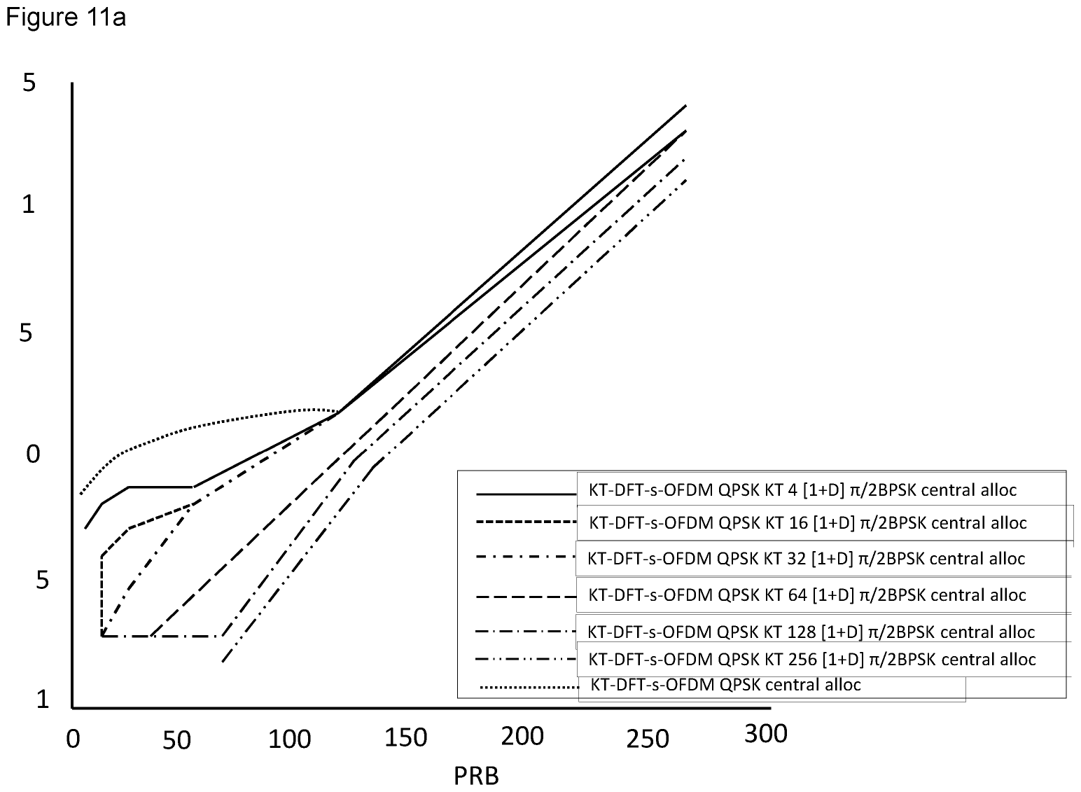

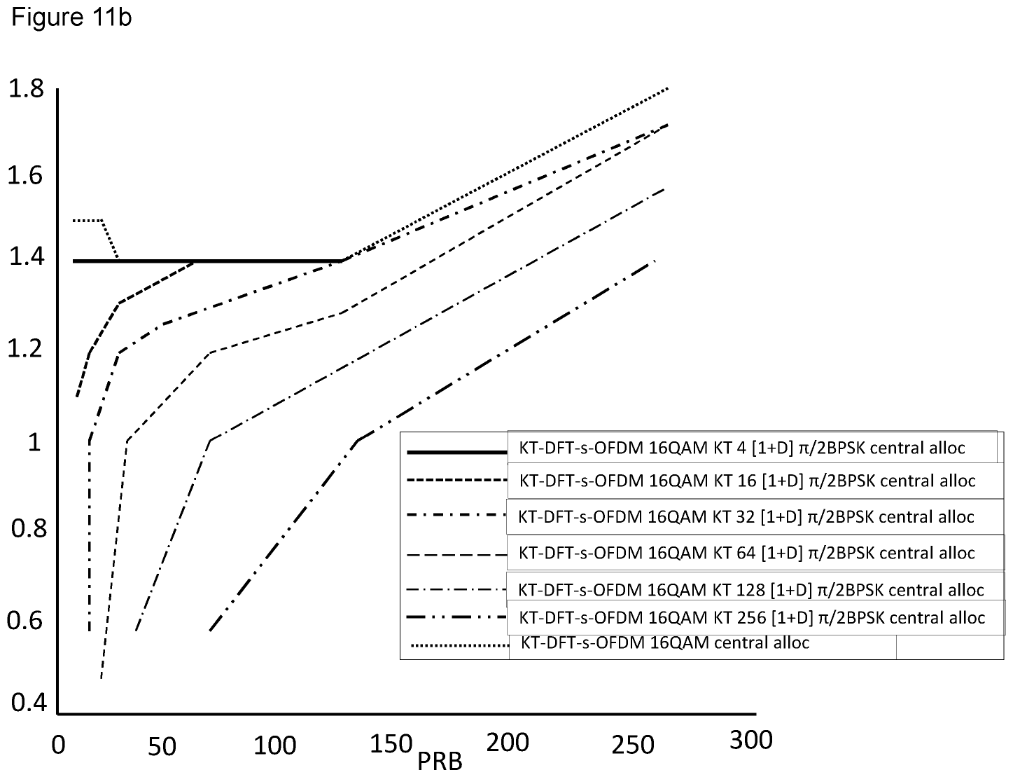

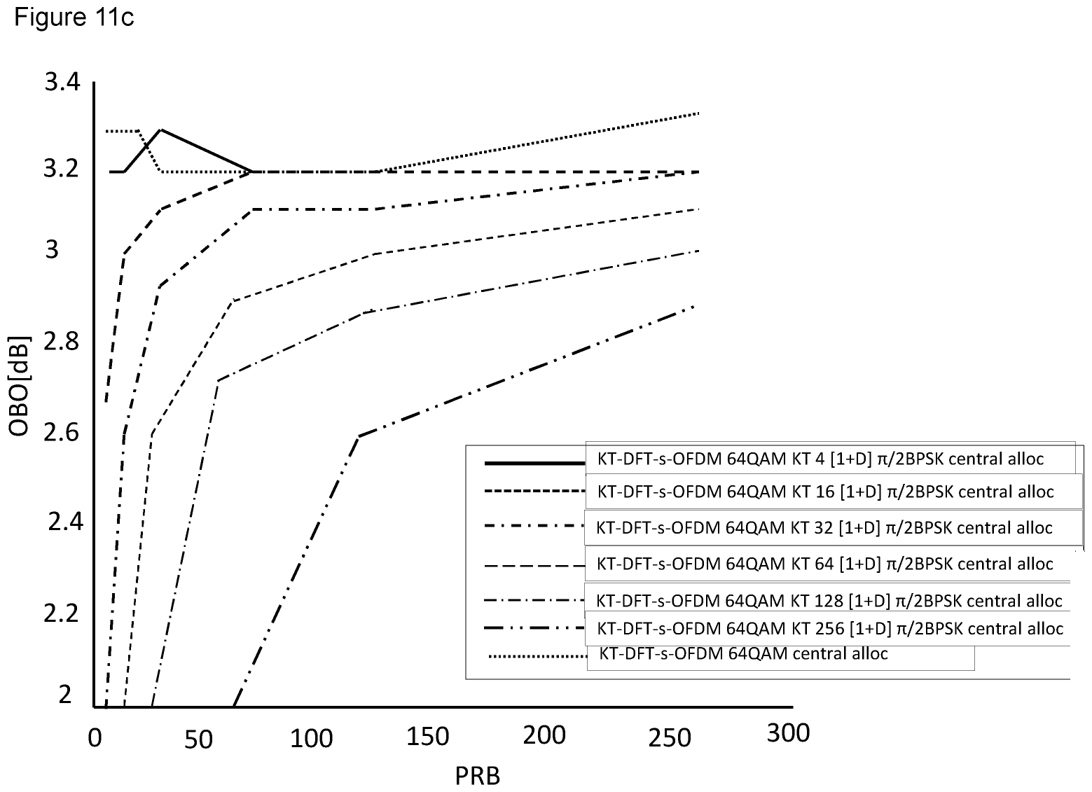

An example of how the KT sequence length affects the MPR requirements is illustrated in FIGS. 11a-c for QPSK, 16QAM and 64 QAM, respectively. The results shown in FIGS. 11a-c have been obtained after transmitting KT-DFT-s-OFDM waveforms (without FDSS or any other technique to reduce the PAPR of the signal) through a realistic PA model with a carrier frequency of 150 GHz. The FR2 RF requirements of EVM, IBE, OBW and SEM are considered. The PA output power is gradually increased, while measuring the corresponding PA output signal with respect to the limits set by the RF requirements. The power is increased until at least one of the signal quality metric is not fulfilled. The OBO (Output Power Backoff) is measured with respect to the power class 1 UE from FR2, negative OBO values mean that the output power is larger than the maximum output power of the UE power class. The KT sequences for the tested case are generated by shaping the PI/2-BPSK sequences with the [1+D] filter (this filter combines two consecutive PI/2-BPSK symbols, reducing the PAPR). It can be seen from the figures that increasing the KT-sequence length, with a proper design of the KT sequences can lead to large output power increase when compared to DFT-s-OFDM (shown for reference).

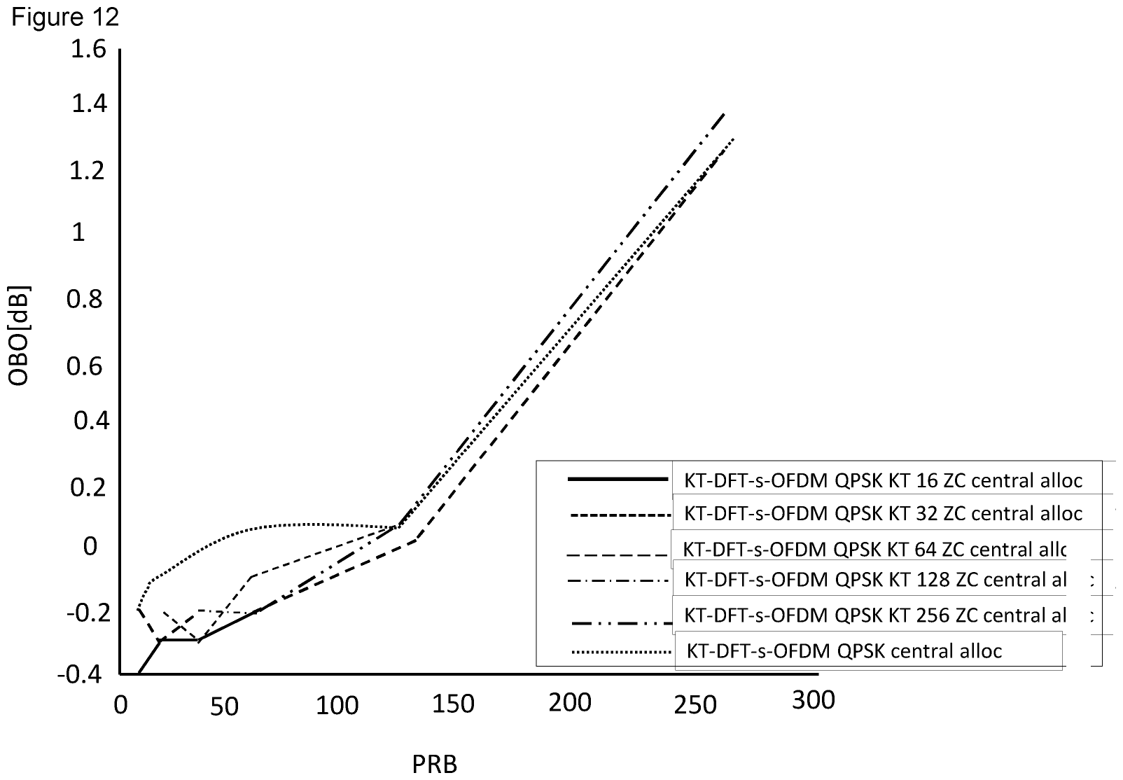

FIG. 12 shows the required OBO when KT sequence corresponds to Zadoff-Chu (ZC). The OBO for KT using ZC sequences is very similar to the one required for DFT-s-OFDM (shown for reference).

Tables 6 to 8 show the output power gain of KT-DFT-s-OFDM with [1+D]PI/2-BPSK KT sequence, with respect to DFT-s-OFDM for QPSK, 16QAM and 64QAM, respectively, giving a quantitative analysis of the achievable gain.

TABLE 6

| | |
|---|---|
| KT | |
| length | PRB allocation |

| (Symbols) | 8 | 16 | 32 | 64 | 128 | 256 |
|---|---|---|---|---|---|---|
| 4 | −0.1 | −0.1 | 0 | 0 | 0.1 | −0.1 |
| 16 | 0.4 | 0.1 | 0 | 0.1 | 0 | 0 |
| 32 | 0.6 | 0.3 | 0.2 | 0.2 | 0 | 0 |
| 64 | N/A | 0.7 | 0.5 | 0.2 | 0.1 | 0 |
| 128 | N/A | N/A | 0.8 | 0.4 | 0.2 | 0.1 |
| 256 | N/A | N/A | N/A | 0.8 | 0.3 | 0.2 |

TABLE 7

| | |
|---|---|
| KT | |
| length | PRB allocation |

| (Symbols) | 8 | 16 | 32 | 64 | 128 | 256 |
|---|---|---|---|---|---|---|
| 4 | 0.1 | 0 | −0.1 | 0 | 0 | 0 |
| 16 | 0.5 | 0.2 | 0 | 0 | 0 | 0.1 |
| 32 | 1.4 | 0.6 | 0.2 | 0 | 0 | 0.1 |
| 64 | N/A | 1.4 | 0.6 | 0.2 | 0.1 | 0.1 |
| 128 | N/A | N/A | 1.3 | 0.6 | 0.2 | 0.2 |
| 256 | N/A | N/A | N/A | 1.3 | 0.6 | 0.4 |

TABLE 8

| | |
|---|---|
| KT | |
| length | PRB allocation |

| (Symbols) | 8 | 16 | 32 | 64 | 128 | 256 |
|---|---|---|---|---|---|---|
| 4 | 0.1 | 0.1 | −0.1 | 0 | 0 | 0 |
| 16 | 0.6 | 0.3 | 0.1 | 0 | 0 | 0.1 |
| 32 | 1.3 | 0.7 | 0.3 | 0.1 | 0.1 | 0.1 |
| 64 | N/A | 1.3 | 0.6 | 0.3 | 0.2 | 0.2 |
| 128 | N/A | N/A | 1.2 | 0.5 | 0.3 | 0.3 |
| 256 | N/A | N/A | N/A | 1.2 | 0.6 | 0.4 |

The method may be implemented at a user equipment as described with reference to FIG. 2 or a device as described with reference to FIG. 3.

The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

An apparatus may comprise means for, at a network, determining one of a first known sequence and at least one second known sequence based on a value of a power metric associated with the respective known sequence, providing configuration information indicative of the determined known sequence to a user equipment and receiving uplink transmission from the user equipment using the determined known sequence, wherein the uplink transmission comprises a waveform comprising the determined known sequence, wherein the waveform is a time domain signal.

Alternatively, or in addition, an apparatus may comprise means for means for, at a user equipment, receiving configuration information indicative of a known sequence from a network, wherein the known sequence is determined by the network based on a value of a power metric associated with the known sequence and providing uplink transmission to the network, wherein the uplink transmission comprises a waveform comprising the known sequence, wherein the waveform is a time domain signal.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims.

Indeed, there is a further embodiment comprising a combination of one or more embodiments with any of the other embodiments previously discussed.

1.-25. (canceled)

26. An apparatus comprising means for, at a network:
determining one of a first known sequence and at least one second known sequence based on a value of a power metric associated with the respective known sequence;
providing configuration information indicative of the determined known sequence to a user equipment; and
receiving uplink transmission from the user equipment using the determined known sequence, wherein the uplink transmission comprises a waveform comprising the determined known sequence, wherein the waveform is a time domain signal.

27. The apparatus according to claim 26, wherein the power metric comprises at least one of peak to average power ratio, maximum power reduction, additional maximum power reduction and output power backoff.

28. The apparatus according to claim 27, wherein the value of the power metric associated with the first known sequence is lower than the value of the power metric associated with the at least one second known sequence.

29. The apparatus according to claim 26, wherein the waveform comprises a known tail discrete Fourier Transform spread orthogonal frequency division multiplexing waveform or a single carrier frequency domain equalization waveform.

30. The apparatus according to claim 26, wherein a length of the first known sequence is longer than a length of the at least one second known sequence.

31. The apparatus according to claim 26, comprising means for receiving information from the user equipment for use in determining the one of the first known sequence and at least one second known sequence.

32. The apparatus according to claim 31, wherein the information comprises an indication of a requested known sequence.

33. The apparatus according to claim 31, comprising means for:
determining one of the first known sequence and the at least one second known sequence based on a power headroom report received from the user equipment.

34. The apparatus according to claim 26, wherein the first known sequence uses a first modulation and the at least one second known sequence uses a second modulation.

35. The apparatus according to claim 26, comprising means for receiving an indication from the user equipment of at least one of supported known sequence lengths, supported known sequences and supported waveform shaping.

36. The apparatus according to claim 35, wherein the configuration information comprises a parameter indicative of the known sequence length or the determined one of the first known tail sequence and the at least one second known tail sequence.

37. An apparatus comprising means for, at a user equipment:
receiving configuration information indicative of a known sequence from a network; and
providing uplink transmission to the network, wherein the uplink transmission comprises a waveform comprising the known sequence, wherein the waveform is a time domain signal.

38. The apparatus according to claim 37, comprising means for selecting the known sequence from a preconfigured table based on the configuration information, wherein the preconfigured table comprises at least two known sequences with different properties for at least one of power metric, sequence length and modulation.

39. The apparatus according to claim 37, comprising means for applying low-pass filtering to the known sequence.

40. The apparatus according to claim 37, comprising means for determining transmit power for the uplink transmission based on the known sequence.

41. The apparatus according to claim 37, comprising means for providing information from the user equipment to the network for use in determining one of a first known sequence and at least one second known sequence.

42. The apparatus according to claim 41, wherein the information comprises an indication of a requested known sequence.

43. The apparatus according to claim 37 comprising means for providing an indication from the user equipment to the network of at least one of supported known sequence lengths, supported known sequences and supported waveform shaping.

44. The apparatus according to claim 37, wherein the known sequence is determined by the network based on a value of a power metric associated with the known sequence.

45. A method comprising, at a user equipment:
receiving configuration information indicative of a known sequence from a network; and
providing uplink transmission to the network, wherein the uplink transmission comprises a waveform comprising the known sequence, wherein the waveform is a time domain signal.
